(19) United States
(12) Patent Application Publication
(10) Pub. No.: US 2019/0102797 A1
(43) Pub. Date: Apr. 4, 2019

(54) DIGITAL SIGNAGE WITH INSTANT CHECKOUT

(71) Applicant: Intel Corporation, Santa Clara, CA (US)

(72) Inventors: Shao-Wen Yang, San Jose, CA (US); Addicam Sanjay, Gilbert, AZ (US); Jose Avalos, Chandler, AZ (US)

(21) Appl. No.: 15/721,450

(22) Filed: Sep. 29, 2017

(51) Int. Cl. G06Q 30/02; G09G 3/20; G09F 9/00

(52) U.S. Cl. CPC G06Q 30/0261; G09G 3/2092; G09G 2354/00; G06Q 30/0272; G09F 9/00; G06Q 30/0269

(57) ABSTRACT

An embodiment of a semiconductor package apparatus may include technology to determine if a user is proximate to a display, determine a characteristic of the user, display a message on the display based on the characteristic of the user, and complete a transaction with the user proximate to the display. Non-limiting examples of environments for some embodiments may include any place where informational messaging is directed at people and where it may be beneficial to adjust such messaging to complete a transaction with the user. Other embodiments are disclosed and claimed.

### TECHNICAL FIELD

Embodiments generally relate to retail display technology. More particularly, embodiments relate to digital signage with instant checkout.

### BACKGROUND

Online retailers may provide a shopping cart and checkout procedure to complete a sale. Some online retailers may provide a faster procedure to complete a sale, such as a buy now procedure or a one-click procedure to complete a sale. Various other environments may provide informational messaging to people.

Internet of things (IoT) devices are physical objects that may communicate on a network, and may include sensors, actuators, and other input/output components, such as to collect data or perform actions from a real world environment. For example, IoT devices may include low-powered devices that are embedded or attached to everyday things, such as buildings, vehicles, packages, etc., to provide an additional level of artificial sensory perception of those things. Recently, IoT devices have become more popular and thus applications using these devices have proliferated.

Various standards have been proposed to more effectively interconnect and operate IoT devices and IoT network use cases. These include the specialization of communication standards distributed by groups such as Institute of Electrical and Electronics Engineers (IEEE), and the specialization of application interaction architecture and configuration standards distributed by groups such as the Open Connectivity Foundation (OCF).

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of semiconductor package apparatus according to an embodiment;

FIGS. 3A to 3C are flowcharts of an example of a method of facilitating a sale according to an embodiment;

FIG. 4 is a block diagram of an example of an instant checkout display apparatus according to an embodiment;

FIG. 5 is a flowchart of another example of a method of facilitating a sale according to an embodiment;

FIG. 6 is a block diagram of an example of a signage-based instant checkout system according to an embodiment;

FIG. 7 illustrates a domain topology for respective internet-of-things (IoT) networks coupled through links to respective gateways, according to an example;

FIG. 8 illustrates a cloud computing network in communication with a mesh network of IoT devices operating as a fog device at the edge of the cloud computing network, according to an example;

FIG. 9 illustrates a block diagram of a network illustrating communications among a number of IoT devices, according to an example; and

FIG. 10 illustrates a block diagram for an example IoT processing system architecture upon which any one or more of the techniques (e.g., operations, processes, methods, and methodologies) discussed herein may be performed, according to an example.

### DESCRIPTION OF EMBODIMENTS

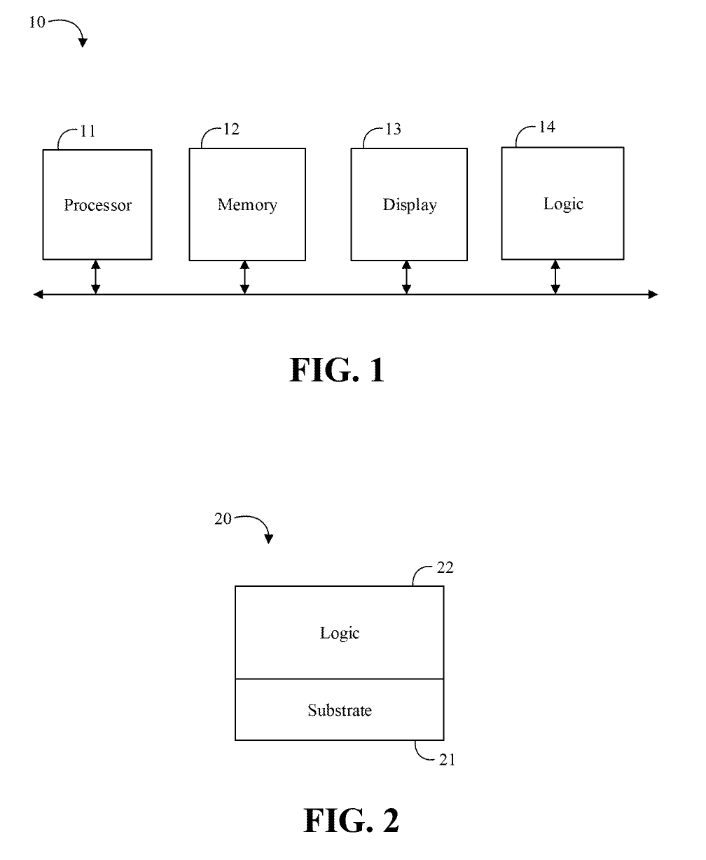

Turning now to FIG. 1, an embodiment of an electronic processing system 10 may include a processor 11, memory 12 communicatively coupled to the processor 11, a display 13 communicatively coupled to the processor 11, and logic 14 communicatively coupled to the processor 11 to determine if a user is proximate to the display 13, determine a characteristic of the user, display a message on the display 13 based on the characteristic of the user, and complete a transaction with the user proximate to the display 13. Non-limiting examples of environments for some embodiments may include any place where informational messaging is directed at people and where it may be beneficial to adjust such messaging to complete a transaction with the user. For example, some embodiments may include display kiosks which may be provided in private or public environments. An embodiment of a kiosk in a museum may ask a user to complete a survey transaction based on what exhibits they visited, and may adjust the messaging based on the determined characteristic of the user (e.g., different questions for younger versus older patrons). An embodiment of a kiosk in an airport may ask a user to complete an identification transaction as part of a pre-boarding process, and may adjust the messaging based on the determined characteristic of the user (e.g., a different color scheme based on the user's emotional state). Another non-limiting example of an application for some embodiments may include a retail environment/application.

In some embodiments of the system 10, the logic 14 may also be configured to track locations of the user relative to articles (e.g., articles for sale), and display a message on the display 13 based on the tracked locations of the user relative to the articles. For example, the logic 14 may also determine if the user interacts with an article, and display a message on the display 13 based on the interaction with the article. In some embodiments of the system 10, the logic 14 may be further configured to display a message on the display 13 which is personalized for the user, and display a value offer which is personalized for the user (e.g., a pricing offer). For example, the logic 14 may display a limited time value offer to the user. In some embodiments, the logic 14 may be further configured to complete a transaction with a cloud-based service proximate to the display 13 (e.g., to complete a sales transaction with a cloud-based payment service).

Embodiments of each of the above processor 11, memory 12, display 13, logic 14, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the memory 12, persistent storage media, or other system memory may store a set of instructions which when executed by the processor 11 cause the system 10 to implement one or more components, features, or aspects of the system 10 (e.g., the logic 14, determining if a user is proximate to the display, determining a characteristic of the user, displaying a message on the display based on the characteristic of the user, completing a transaction with the user proximate to the display, etc.).

Turning now to FIG. 2, an embodiment of a semiconductor package apparatus 20 may include a substrate 21, and logic 22 coupled to the substrate 21, where the logic 22 is at least partly implemented in one or more of configurable logic and fixed-functionality hardware logic. The logic 22 coupled to the substrate 21 may be configured to determine if a user is proximate to a display, determine a characteristic of the user, display a message on the display based on the characteristic of the user, and complete a transaction with the user proximate to the display. In some embodiments, the logic 22 may also be configured to track locations of the user relative to articles, and display a message on the display based on the tracked locations of the user relative to the articles. For example, the logic 22 may also determine if the user interacts with an article, and display a message on the display based on the interaction with the article. In some embodiments, the logic 22 may be further configured to display a message on the display which is personalized for the user, and display a value offer which is personalized for the user. For example, the logic 22 may display a limited time value offer to the user. In some embodiments, the logic 22 may be further configured to complete a transaction with a cloud-based service proximate to the display.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

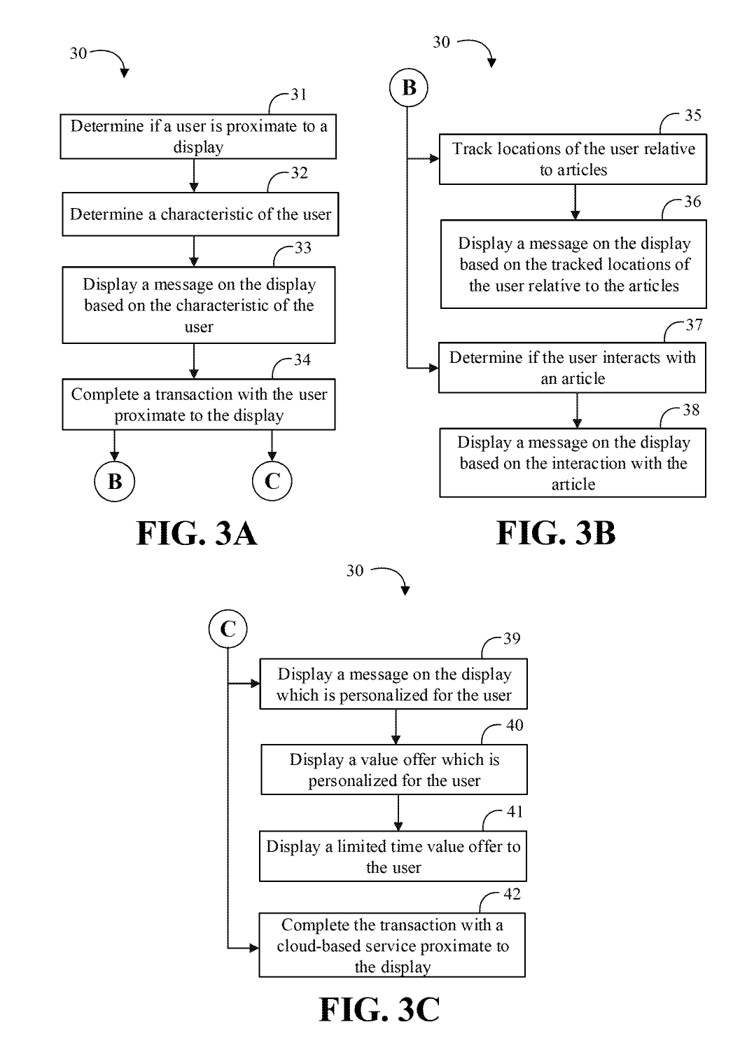

Turning now to FIGS. 3A to 3C, an embodiment of a method 30 of facilitating a transaction may include determining if a user is proximate to a display at block 31, determining a characteristic of the user at block 32, displaying a message on the display based on the characteristic of the user at block 33, and completing a transaction with the user proximate to the display at block 34. In some embodiments, the method 30 may also include tracking locations of the user relative to articles at block 35, and displaying a message on the display based on the tracked locations of the user relative to the articles at block 36. The method 30 may also include determining if the user interacts with an article at block 37, and displaying a message on the display based on the interaction with the article at block 38. Some embodiments of the method 30 may include displaying a message on the display which is personalized for the user at block 39, and displaying a value offer which is personalized for the user at block 40. For example, some embodiments may include displaying a limited time value offer to the user at block 41. The method 30 may also include completing a transaction with a cloud-based service proximate to the display at block 42.

Embodiments of the method 30 may be implemented in a system, apparatus, computer, device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 30 may be implemented on a computer readable medium as described in connection with Examples 19 to 24 below. Embodiments or portions of the method 30 may be implemented in applications (e.g., through an application programming interface (API)) or driver software running on an operating system (OS).

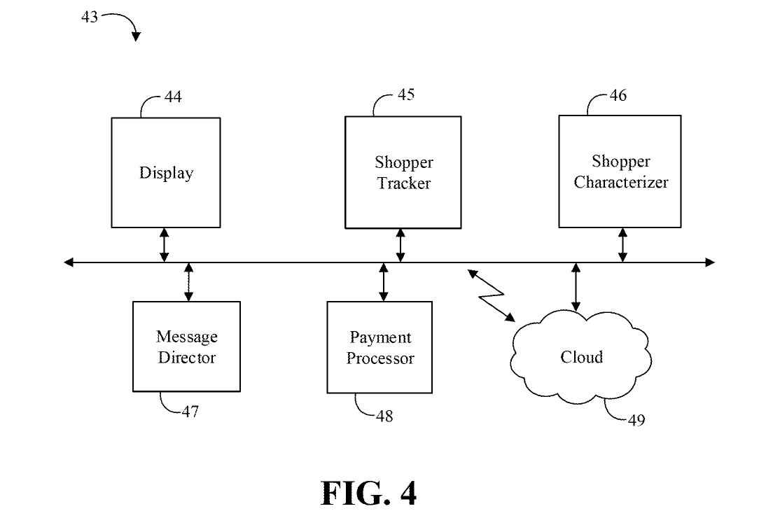

Turning now to FIG. 4, some embodiments may include technology that is logically or physically arranged as one or more modules. For example, an embodiment of an instant checkout display signage 43 may include a display 44, a shopper tracker 45, a shopper characterizer 46, a message director 47, and a payment processor 48. The shopper tracker 45 may determine if a user is proximate to the display 44. The shopper characterizer 46 may determine a characteristic of the user, and the message director 47 may cause a message to be displayed on the display 44 based on the characteristic of the user. The payment processor 48 may complete a transaction with the user proximate to the display 44. In some embodiments, the shopper tracker 45 may also be configured to track locations of the user relative to articles for sale, and the message director 47 may cause a message to be displayed on the display 44 based on the tracked locations of the user relative to the articles for sale. For example, the shopper tracker 45 may also determine if the user interacts with an article for sale, and the message director 47 may cause a message to be displayed on the display 44 based on the interaction with the article for sale. In some embodiments, the message director 47 may be further configured to cause a message to be displayed on the display 44 which is personalized for the user, and to cause a value offer to be displayed on the display 44 which is personalized for the user. For example, the message director 47 may cause a limited time value offer to be displayed to the user.

In some embodiments, the payment processor 48 may be further configured to complete a sales transaction with a cloud-based payment service proximate to the display. For example, the instant checkout display signage 43 may include a connection to the cloud 49. The cloud connection may be wired, wireless, or a hybrid combination thereof. For example, one or more network nodes may be wired with electrically conducting or optical connections. In some embodiments, the instant checkout display signage 43 may provide updates to a cloud service and/or may receive updates from a cloud service. For example, various databases or information useful to the shopper tracker 45, the shopper characterizer 46, the message director 47, and/or the payment processor 48 may be downloaded from the cloud 49 and/or maintained/provided by a cloud service. Similarly, information originating from any of the shopper tracker 45, the shopper characterizer 46, the message director 47, and/or the payment processor 48 may be uploaded to the cloud 49.

Embodiments of the display 44, the shopper tracker 45, the shopper characterizer 46, the message director 47, the payment processor 48, the cloud 49, and other components of the instant checkout display signage 43, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

Some embodiments may advantageously provide interactive instant-checkout signage using directed advertising and pricing. Some shoppers may go to a physical store just to look at a product they intend to buy online such that a physical store may be considered a showroom. Brick-and-mortar retailers may lose in-store customers for the lack of personalization (e.g., directed pricing and direct advertising), which may be challenging to implement in brick-and-mortar retailers. Another challenge for physical store retailers is competing with the online user experience. Some embodiments may advantageously provide a better user experience with directed advertising, directed pricing, and/or a more convenient checkout process.

In brick-and-mortar retailers, reduction of time-to-sale may significantly increase the success of a sale either before the shopper changes their mind or by not losing the sale to online retailers. Some embodiments may advantageously reduce the time-to-sale (e.g., the time from an ad or pricing delivered to a user to the user being able to checkout) by providing a digital sign with point-of-sale (POS) features. For example, an embodiment of an integrated POS-capable signage may determine appropriate directed advertising/pricing for a shopper and play corresponding ads or display products of interest to a shopper (e.g., together with a directed pricing offer) in order to increase the probability of a successful sale. The integrated POS-capable signage may allow the shopper to instantly complete a sale before the directed offer expires and/or before the shopper changes their mind. Some embodiments may include cloud-based payment services which may allow the brick-and-mortar retailer to more effectively compete with prices from online retailers and/or provide the security of an automatic payment.

Advantageously, some embodiments may reduce or minimize the time-to-sale. Integrated POS-capable signage may allow the shopper to complete the sale with less effort to the shopper. The shopper may check out instantly at the digital sign where the ads or pricing is delivered. Some embodiments may provide the shopper with more payment security because the signage-based automatic payment may be clerk-free. For example, some embodiments may include cloud-based payment which may leverage the state of the art in online payment systems (e.g., such as APPLE PAY, SAMSUNG PAY, etc.) to ensure transaction security. Some embodiments may also provide flexibility with cloud-based solutions which may allow a brick-and-mortar retailer to offer competitive pricing to shoppers for an increased probability of sale.

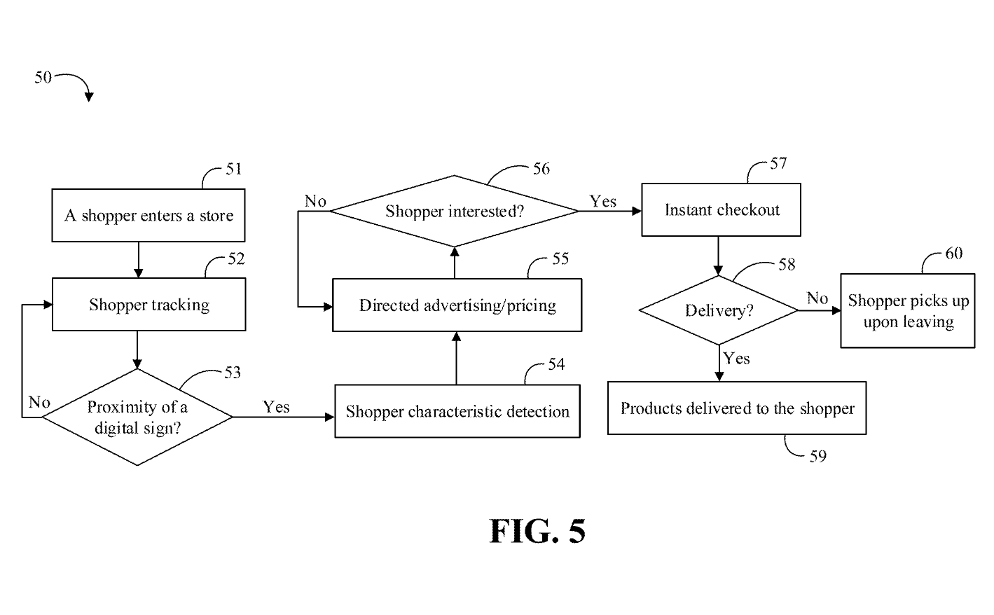

Turning now to FIG. 5, a method 50 of facilitating a transaction may start when a shopper enters a store at block 51. The movement and/or location of the shopper may be tracked at block 52 and the method 50 may determine if the shopper is in the proximity of a digital sign at block 53. If not, the tracking may continue at block 52. When the shopper is determined to be in the proximity of the digital sign at block 53, one or more characteristics of the shopper may be detected at block 54. For example, useful characteristics which may be detected may include demographic information (e.g., age, gender, ethnicity, etc.) and/or emotional state (e.g., happy, frustrated, etc.). Other characteristics may include the user response time between when a message is presented and the transaction completion (e.g., as a characteristic that may get added to the user characteristic data), and/or duration that the user is proximate to the digital sign (e.g., whether the user is continuously proximate to the digital sign, or leaves and returns). The method 50 may then provide directed advertising and/or pricing to the shopper based on their proximity and/or the detected characteristics. If the shopper is not interested at block 56, the method 50 may provide alternative directed advertising/pricing to the shopper at block 55. If the shopper is interested in completing a sales transaction at block 56, the method 50 may provide an instant checkout procedure at block 57. Depending on the article sold, the shopper may be provided with a delivery option at block 58 where the shopper may have the products delivered at block 59 or the shopper may pick up the product upon leaving the store at block 60 (e.g., or simply leave with the product if the shopper already had the product in hand).

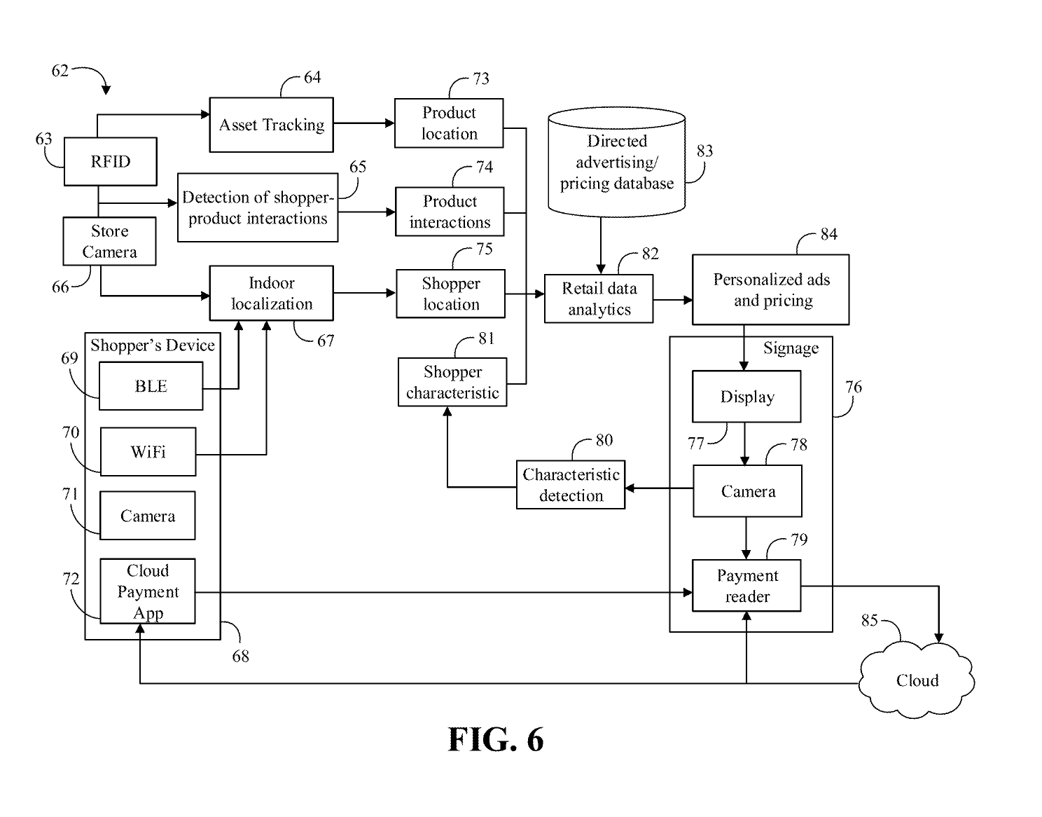

Turning now to FIG. 6, an embodiment of a signage-based instant checkout system 62 may include radio frequency identification (RFID) technology 63 used for asset tracking 64 and detection of shopper-product interactions 65. The system 62 may also include store cameras 66 used for the detection of shopper-product interactions 65 and also indoor localization 67. The shopper may carry a device 68 (e.g., a tablet or smartphone device) which may include various components that cooperate with or provide useful information to the system 62. For example, the device may include one or more radios (such as a BLUETOOTH LOW ENERGY (BLE) radio 69 and/or a WIFI radio 70), a camera 71, and a cloud payment app 72 (e.g., such as APPLE PAY, SAMSUNG PAY, etc.). In some embodiments, the radios 69, 70 on the shopper's device 68 may be used for the indoor localization 67.

The asset tracking 64 may provide product location information 73, while the detection of shopper-product interactions 65 may provide product interaction information 74 and the indoor localization 67 may provide shopper location information 75. The system 62 may further include digital signage 76 having a display 77, one or more cameras 78, and one or more payment readers 79. The cameras 78 may be configured for human characteristic detection 80 to provide shopper characteristic information 81. Retail analytics 82 may get information from a directed advertising/pricing database 83 which the retail analytics 82 may analyze together with the product location information 73, the product interaction information 74, the shopper location information 75, and the shopper characteristic information 81 to provide personalized advertising and/or pricing 84 for the shopper.

Because the signage 76 itself includes the payment reader 79, the signage 76 may offer instant checkout ability for products that the shopper may be interested in. For example, the payment reader may be connected to the cloud 85 and enable the shopper to use a cloud payment service on their device 68 to complete a sales transaction. In some embodiments, the signage 76 may cause a pricing offer to be displayed on the display 77 that expires after a time period (e.g., one minute) or when the shopper leaves the proximity of the signage 76. Other bundled or personalized pricing offers may be presented to the shopper based on the retail analytics 82, advantageously providing flexible and competitive technology for brick-and-mortar retailers to compete with online retailers.

Any useful technology may be utilized for the various components of the system 62. The asset tracking may be performed using RFID technology which may determine the location of RFID tags within a few meters at over 90% accuracy. An indoor positioning system (IPS) may be utilized for indoor localization. Depending on whether the shopper is carrying their device in their hand, a pocket, or a bag, accuracy of the shopper's location may be determined from less than 1 meter (handheld) to within a few meters (pocket) or several meters (bag). A vision system may also be used (e.g., alone or in combination with radio signals) to more accurately determine a shopper's proximity to products by pre-labeling zones in regions of camera views.

RFID technology may also be used to detect shopper-product interactions. For example, when the customer moves around or pick up a product, the shopper may interfere with the signal propagation path between an RFID reader and the RFID tag attached to the product. This interference may cause a signal fluctuation and as a result, may manifest itself as a variation in low-level signals including phase, received signal strength indicator (RSSI), and a Doppler-shifted signal. The intensity of the signal variation may be based on how the customer interacts with the product. For example, a direct interaction (e.g., the shopper picks up a product) may yield a stronger signal interference than an indirect interaction (e.g., the shopper walks around a specific shopping area without picking up anything). Accordingly, different behaviors of the shopper may introduce distinct types of interference between the RFID reader and the tags. Some embodiments may utilize these signal patterns to infer the behavior of the shopper, including but not limiting to, the duration of standing/walking around a shopping area, the duration and timestamps of picking up a product, etc. A machine learning application may be trained to provide a decision tree which in some embodiments may provide reasonable accuracy in differentiating situations including nothing moving around the tag or RFID reader (e.g., stationary), human motion near the tag (e.g., interference), and picking up the object and interacting with it (e.g., motion).

Any useful retail data analytics may be applied to the product location information, shopper location information, shopper-product interaction information, and/or shopper characteristic information (e.g., or other information specific to a particular retail environment). Such analytics may vary widely depending on the particular retailer and/or store environment. Advantageously, some embodiment may provide flexibility in the personalized messaging/pricing which may be readily adapted to a particular retail environment, together with the ability to offer a shopper an instant checkout experience. Similarly, any useful technology may be employed for detection of relevant shopper characteristics such as age, gender, ethnicity, emotional state, response time, etc. Deep learning techniques may provide good results for face detection, face recognition and emotion recognition, and may also be applied to other shopper characteristics such as age and/or ethnicity (e.g., deep neural networks such as MTCNN, DEEPFACE, HOLONET, etc.).

Some embodiments may include an INTEL AIM SUITE sensor. AIM SUITE may provide objective, quantitative measurement and analysis of what consumers are doing in retail and other spaces, all in real-time and aggregated reporting. Using anonymous sensors and highly sophisticated computer algorithms, AIM SUITE may accurately count the potential and actual audiences for visual messages and merchandising. AIM SUITE may also profile viewers by variables as broad as gender and age range, to as specific as viewing times and durations.

Many of the embodiments described herein may include a display. Such displays may include flat panel display technology and advanced features such as touch screens, cameras, gesture recognition, etc. integrated with the displays. In some embodiments, such displays may alternatively, or additionally, include numerical and digital letter displays that may present numbers or letters or a scrolling display of same.

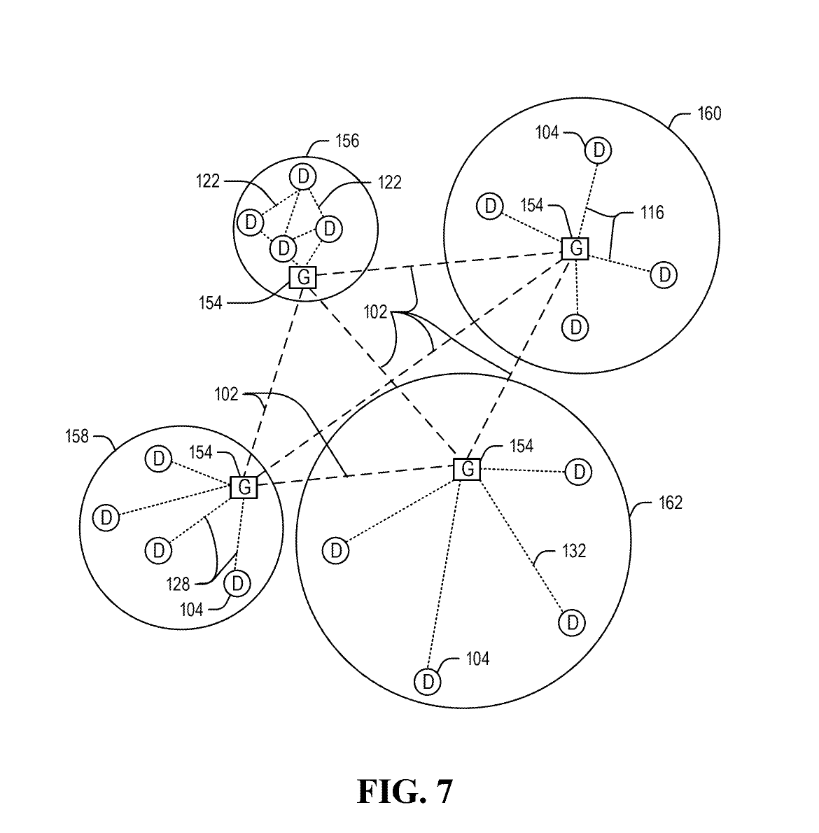

FIG. 7 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

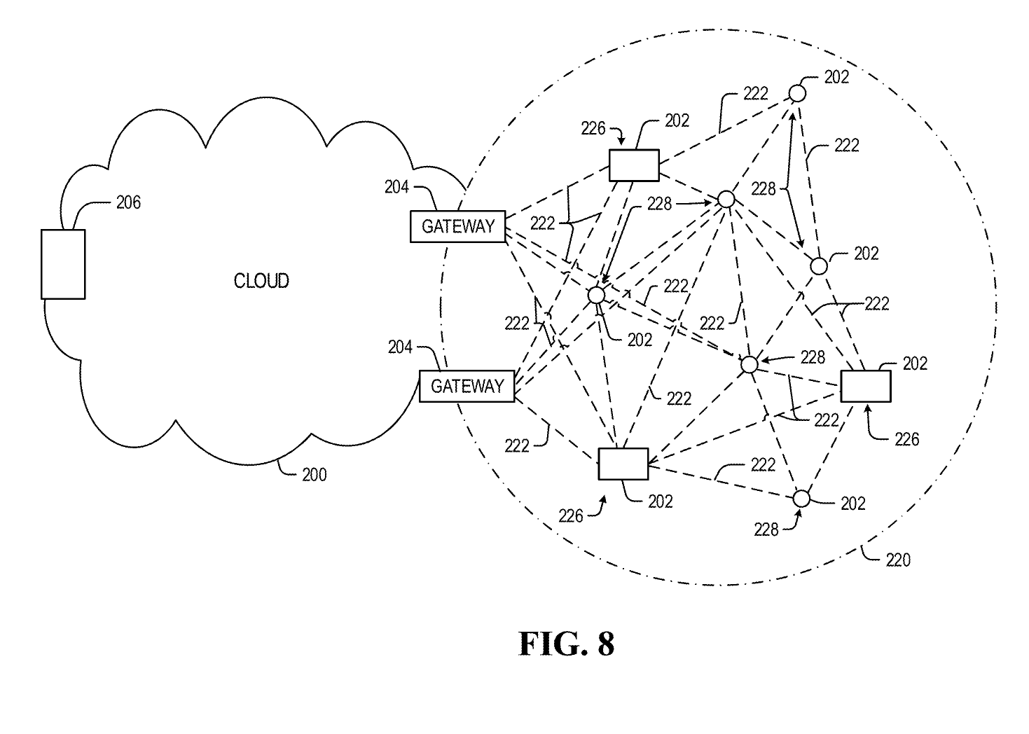

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 7 and 8, present a number of new challenges in a heterogeneous network of connectivity comprising a combination of wired and wireless technologies.

FIG. 7 specifically provides a simplified drawing of a domain topology that may be used for a number of internet-of-things (IoT) networks comprising IoT devices 104, with the IoT networks 156, 158, 160, 162, coupled through backbone links 102 to respective gateways 154. For example, a number of IoT devices 104 may communicate with a gateway 154, and with each other through the gateway 154. To simplify the drawing, not every IoT device 104, or communications link (e.g., link 116, 122, 128, or 132) is labeled. The backbone links 102 may include any number of wired or wireless technologies, including optical networks, and may be part of a local area network (LAN), a wide area network (WAN), or the Internet. Additionally, such communication links facilitate optical signal paths among both IoT devices 104 and gateways 154, including the use of MUXing/deMUXing components that facilitate interconnection of the various devices.

The network topology may include any number of types of IoT networks, such as a mesh network provided with the network 156 using Bluetooth low energy (BLE) links 122. Other types of IoT networks that may be present include a wireless local area network (WLAN) network 158 used to communicate with IoT devices 104 through IEEE 802.11 (Wi-Fi®) links 128, a cellular network 160 used to communicate with IoT devices 104 through an LTE/LTE-A (4G) or 5G cellular network, and a low-power wide area (LPWA) network 162, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into as fog devices or systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 104, such as over the backbone links 102, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 156, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 158, for instance, may use systems that perform standards conversion to provide multi-standard connectivity, enabling IoT devices 104 using different protocols to communicate. Further systems may provide seamless interconnectivity across a multi-standard infrastructure comprising visible Internet resources and hidden Internet resources.

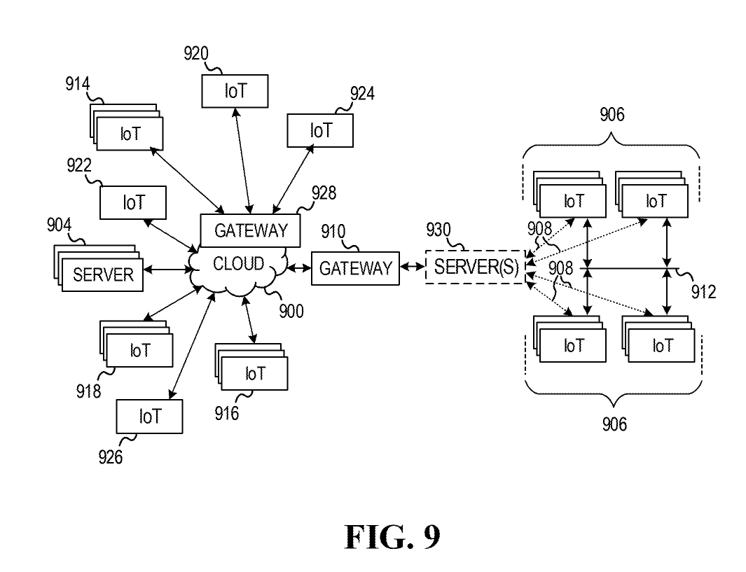

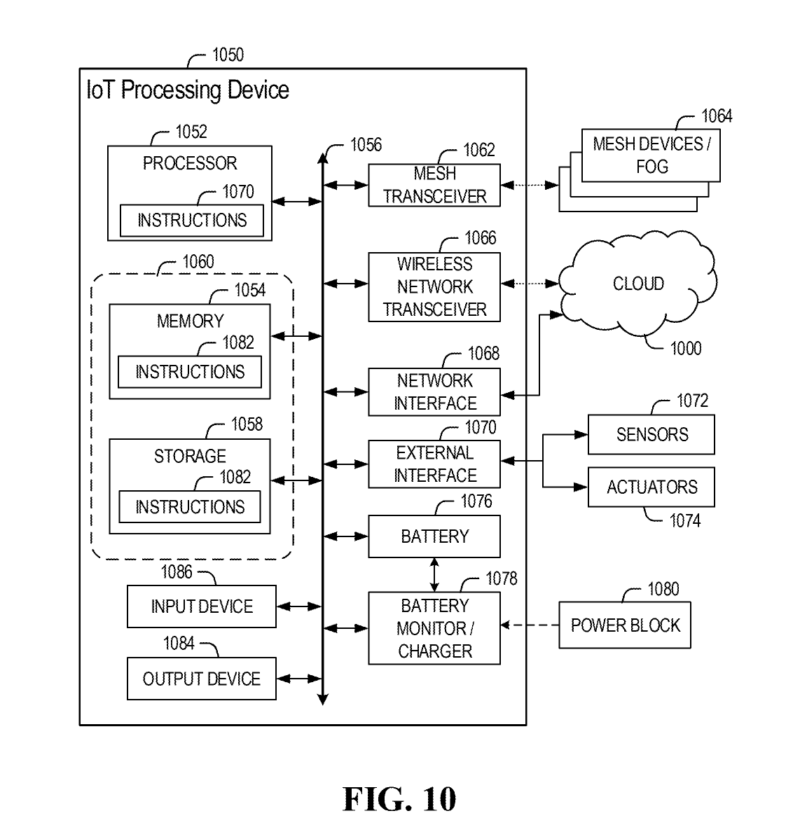

Communications in the cellular network 160, for instance, may be enhanced by systems that offload data, extend communications to more remote devices, or both. The LPWA network 162 may include systems that perform non-Internet protocol (IP) to IP interconnections, addressing, and routing. Further, each of the IoT devices 104 may include the appropriate transceiver for wide area communications with that device. Further, each IoT device 104 may include other transceivers for communications using additional protocols and frequencies. This is discussed further with respect to the communication environment and hardware of an IoT processing device depicted in FIGS. 9 and 10.

Finally, clusters of IoT devices may be equipped to communicate with other IoT devices as well as with a cloud network. This may allow the IoT devices to form an ad-hoc network between the devices, allowing them to function as a single device, which may be termed a fog device. This configuration is discussed further with respect to FIG. 8 below.

FIG. 8 illustrates a cloud computing network in communication with a mesh network of IoT devices (devices 202) operating as a fog device at the edge of the cloud computing network. The mesh network of IoT devices may be termed a fog 220, operating at the edge of the cloud 200. To simplify the diagram, not every IoT device 202 is labeled.

The fog 220 may be considered to be a massively interconnected network wherein a number of IoT devices 202 are in communications with each other, for example, by radio links 222. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 202 are shown in this example, gateways 204, data aggregators 226, and sensors 228, although any combinations of IoT devices 202 and functionality may be used. The gateways 204 may be edge devices that provide communications between the cloud 200 and the fog 220, and may also provide the backend process function for data obtained from sensors 228, such as motion data, flow data, temperature data, and the like. The data aggregators 226 may collect data from any number of the sensors 228, and perform the back end processing function for the analysis. The results, raw data, or both may be passed along to the cloud 200 through the gateways 204. The sensors 228 may be full IoT devices 202, for example, capable of both collecting data and processing the data. In some cases, the sensors 228 may be more limited in functionality, for example, collecting the data and allowing the data aggregators 226 or gateways 204 to process the data.

Communications from any IoT device 202 may be passed along a convenient path (e.g., a most convenient path) between any of the IoT devices 202 to reach the gateways 204. In these networks, the number of interconnections provide substantial redundancy, allowing communications to be maintained, even with the loss of a number of IoT devices 202. Further, the use of a mesh network may allow IoT devices 202 that are very low power or located at a distance from infrastructure to be used, as the range to connect to another IoT device 202 may be much less than the range to connect to the gateways 204.

The fog 220 provided from these IoT devices 202 may be presented to devices in the cloud 200, such as a server 206, as a single device located at the edge of the cloud 200, e.g., a fog device. In this example, the alerts coming from the fog device may be sent without being identified as coming from a specific IoT device 202 within the fog 220. In this fashion, the fog 220 may be considered a distributed platform that provides computing and storage resources to perform processing or data-intensive tasks such as data analytics, data aggregation, and machine-learning, among others.

In some examples, the IoT devices 202 may be configured using an imperative programming style, e.g., with each IoT device 202 having a specific function and communication partners. However, the IoT devices 202 forming the fog device may be configured in a declarative programming style, allowing the IoT devices 202 to reconfigure their operations and communications, such as to determine needed resources in response to conditions, queries, and device failures. As an example, a query from a user located at a server 206 about the operations of a subset of equipment monitored by the IoT devices 202 may result in the fog 220 device selecting the IoT devices 202, such as particular sensors 228, needed to answer the query. The data from these sensors 228 may then be aggregated and analyzed by any combination of the sensors 228, data aggregators 226, or gateways 204, before being sent on by the fog 220 device to the server 206 to answer the query. In this example, IoT devices 202 in the fog 220 may select the sensors 228 used based on the query, such as adding data from flow sensors or temperature sensors. Further, if some of the IoT devices 202 are not operational, other IoT devices 202 in the fog 220 device may provide analogous data, if available.

In other examples, the operations and functionality described above with reference to FIGS. 1 to 6 may be embodied by a IoT device machine in the example form of an electronic processing system, within which a set or sequence of instructions may be executed to cause the electronic processing system to perform any one of the methodologies discussed herein, according to an example embodiment. The machine may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine. Further, while only a single machine may be depicted and referenced in the example above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor (e.g., a computer) to individually or jointly execute instructions to perform any one or more of the methodologies discussed herein.

FIG. 9 illustrates a drawing of a cloud computing network, or cloud 900, in communication with a number of Internet of Things (IoT) devices. The cloud 900 may represent the Internet, or may be a local area network (LAN), or a wide area network (WAN), such as a proprietary network for a company. The IoT devices may include any number of different types of devices, grouped in various combinations. For example, a traffic control group 906 may include IoT devices along streets in a city. These IoT devices may include stoplights, traffic flow monitors, cameras, weather sensors, and the like. The traffic control group 906, or other subgroups, may be in communication with the cloud 900 through wired or wireless links 908, such as LPWA links, optical links, and the like. Further, a wired or wireless sub-network 912 may allow the IoT devices to communicate with each other, such as through a local area network, a wireless local area network, and the like. The IoT devices may use another device, such as a gateway 1010 or 1028 to communicate with remote locations such as the cloud 1000; the IoT devices may also use one or more servers 1030 to facilitate communication with the cloud 1000 or with the gateway 1010. For example, the one or more servers 1030 may operate as an intermediate network node to support a local edge cloud or fog implementation among a local area network. Further, the gateway 1028 that is depicted may operate in a cloud-to-gateway-to-many edge devices configuration, such as with the various IoT devices 1014, 1020, 1024 being constrained or dynamic to an assignment and use of resources in the cloud 1000.

Other example groups of IoT devices may include remote weather stations 914, local information terminals 916, alarm systems 918, automated teller machines 920, alarm panels 922, or moving vehicles, such as emergency vehicles 924 or other vehicles 926, among many others. Each of these IoT devices may be in communication with other IoT devices, with servers 904, with another IoT fog device or system (not shown, but depicted in FIG. 7), or a combination therein. The groups of IoT devices may be deployed in various residential, commercial, and industrial settings (including in both private or public environments).

As can be seen from FIG. 9, a large number of IoT devices may be communicating through the cloud 900. This may allow different IoT devices to request or provide information to other devices autonomously. For example, a group of IoT devices (e.g., the traffic control group 906) may request a current weather forecast from a group of remote weather stations 914, which may provide the forecast without human intervention. Further, an emergency vehicle 924 may be alerted by an automated teller machine 920 that a burglary is in progress. As the emergency vehicle 924 proceeds towards the automated teller machine 920, it may access the traffic control group 906 to request clearance to the location, for example, by lights turning red to block cross traffic at an intersection in sufficient time for the emergency vehicle 924 to have unimpeded access to the intersection.

Clusters of IoT devices, such as the remote weather stations 914 or the traffic control group 906, may be equipped to communicate with other IoT devices as well as with the cloud 900. This may allow the IoT devices to form an ad-hoc network between the devices, allowing them to function as a single device, which may be termed a fog device or system (e.g., as described above with reference to FIG. 7).

FIG. 10 is a block diagram of an example of components that may be present in an IoT device 1050 for implementing the techniques described herein. The IoT device 1050 may include any combinations of the components shown in the example or referenced in the disclosure above. The components may be implemented as ICs, portions thereof, discrete electronic devices, or other modules, logic, hardware, software, firmware, or a combination thereof adapted in the IoT device 1050, or as components otherwise incorporated within a chassis of a larger system. Additionally, the block diagram of FIG. 10 is intended to depict a high-level view of components of the IoT device 1050. However, some of the components shown may be omitted, additional components may be present, and different arrangement of the components shown may occur in other implementations.

The IoT device 1050 may include a processor 1052, which may be a microprocessor, a multi-core processor, a multithreaded processor, an ultra-low voltage processor, an embedded processor, or other known processing element. The processor 1052 may be a part of a system on a chip (SoC) in which the processor 1052 and other components are formed into a single integrated circuit, or a single package, such as the Edison™ or Galileo™ SoC boards from Intel. As an example, the processor 1052 may include an Intel® Architecture Core™ based processor, such as a Quark™, an Atom™ an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc.

The processor 1052 may communicate with a system memory 1054 over an interconnect 1056 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1058 may also couple to the processor 1052 via the interconnect 1056. In an example the storage 1058 may be implemented via a solid state disk drive (SSDD). Other devices that may be used for the storage 1058 include flash memory cards, such as SD cards, microSD cards, xD picture cards, and the like, and USB flash drives. In low power implementations, the storage 1058 may be on-die memory or registers associated with the processor 1052. However, in some examples, the storage 1058 may be implemented using a micro hard disk drive (HDD). Further, any number of new technologies may be used for the storage 1058 in addition to, or instead of, the technologies described, such resistance change memories, phase change memories, holographic memories, or chemical memories, among others.

The components may communicate over the interconnect 1056. The interconnect 1056 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1056 may be a proprietary bus, for example, used in a SoC based system. Other bus systems may be included, such as an I2C interface, an SPI interface, point to point interfaces, and a power bus, among others.

The interconnect 1056 may couple the processor 1052 to a mesh transceiver 1062, for communications with other mesh devices 1064. The mesh transceiver 1062 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 1064. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 1062 may communicate using multiple standards or radios for communications at different range. For example, the IoT device 1050 may communicate with close devices, e.g., within about 10 meters, using a local transceiver based on BLE, or another low power radio, to save power. More distant mesh devices 1064, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 1066 may be included to communicate with devices or services in the cloud 1000 via local or wide area network protocols. The wireless network transceiver 1066 may be a LPWA transceiver that follows the IEEE 802.15.4, or IEEE 802.15.4g standards, among others. The IoT device 1050 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 1062 and wireless network transceiver 1066, as described herein. For example, the radio transceivers 1062 and 1066 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 1062 and 1066 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 1066, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1068 may be included to provide a wired communication to the cloud 1000 or to other devices, such as the mesh devices 1064. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 1068 may be included to allow connect to a second network, for example, a NIC 1068 providing communications to the cloud over Ethernet, and a second NIC 1068 providing communications to other devices over another type of network.

The interconnect 1056 may couple the processor 1052 to an external interface 1070 that is used to connect external devices or subsystems. The external devices may include sensors 1072, such as accelerometers, level sensors, flow sensors, optical light sensors, camera sensors, temperature sensors, a global positioning system (GPS) sensors, pressure sensors, barometric pressure sensors, and the like. The external interface 1070 further may be used to connect the IoT device 1050 to actuators 1074, such as power switches, valve actuators, an audible sound generator, a visual warning device, and the like.

In some optional examples, various input/output (I/O) devices may be present within, or connected to, the IoT device 1050. For example, a display or other output device 1084 may be included to show information, such as sensor readings or actuator position. An input device 1086, such as a touch screen or keypad may be included to accept input. An output device 1084 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 1050.

A battery 1076 may power the IoT device 1050, although in examples in which the IoT device 1050 is mounted in a fixed location, it may have a power supply coupled to an electrical grid. The battery 1076 may be a lithium ion battery, or a metal-air battery, such as a zinc-air battery, an aluminum-air battery, a lithium-air battery, and the like.

A battery monitor/charger 1078 may be included in the IoT device 1050 to track the state of charge (SoCh) of the battery 1076. The battery monitor/charger 1078 may be used to monitor other parameters of the battery 1076 to provide failure predictions, such as the state of health (SoH) and the state of function (SoF) of the battery 1076. The battery monitor/charger 1078 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1078 may communicate the information on the battery 1076 to the processor 1052 over the interconnect 1056. The battery monitor/charger 1078 may also include an analog-to-digital (ADC) convertor that allows the processor 1052 to directly monitor the voltage of the battery 1076 or the current flow from the battery 1076. The battery parameters may be used to determine actions that the IoT device 1050 may perform, such as transmission frequency, mesh network operation, sensing frequency, and the like.

A power block 1080, or other power supply coupled to a grid, may be coupled with the battery monitor/charger 1078 to charge the battery 1076. In some examples, the power block 1080 may be replaced with a wireless power receiver to obtain the power wirelessly, for example, through a loop antenna in the IoT device 1050. A wireless battery charging circuit, such as an LTC4020 chip from Linear Technologies of Milpitas, Calif., among others, may be included in the battery monitor/charger 1078. The specific charging circuits chosen depend on the size of the battery 1076, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1058 may include instructions 1082 in the form of software, firmware, or hardware commands to implement the techniques described herein. Although such instructions 1082 are shown as code blocks included in the memory 1054 and the storage 1058, it may be understood that any of the code blocks may be replaced with hardwired circuits, for example, built into an application specific integrated circuit (ASIC).

In an example, the instructions 1082 provided via the memory 1054, the storage 1058, or the processor 1052 may be embodied as a non-transitory, machine readable medium 1060 including code to direct the processor 1052 to perform electronic operations in the IoT device 1050. The processor 1052 may access the non-transitory, machine readable medium 1060 over the interconnect 1056. For instance, the non-transitory, machine readable medium 1060 may be embodied by devices described for the storage 1058 of FIG. 10 or may include specific storage units such as optical disks, flash drives, or any number of other hardware devices. The non-transitory, machine readable medium 1060 may include instructions to direct the processor 1052 to perform a specific sequence or flow of actions, for example, as described with respect to the flowchart(s) and block diagram(s) of operations and functionality depicted above.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include, but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules, and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

### ADDITIONAL NOTES AND EXAMPLES

Example 1 may include an electronic processing system, comprising a processor, memory communicatively coupled to the processor, a display communicatively coupled to the processor, and logic communicatively coupled to the processor to determine if a user is proximate to the display, determine a characteristic of the user, display a message on the display based on the characteristic of the user, and complete a transaction with the user proximate to the display.

Example 2 may include the system of Example 1, wherein the logic is further to track locations of the user relative to articles, and display a message on the display based on the tracked locations of the user relative to the articles.

Example 3 may include the system of Example 1, wherein the logic is further to determine if the user interacts with an article, and display a message on the display based on the interaction with the article.

Example 4 may include the system of Example 1, wherein the logic is further to display a message on the display which is personalized for the user, and display a value offer which is personalized for the user.

Example 5 may include the system of Example 4, wherein the logic is further to display a limited time value offer to the user.

Example 6 may include the system of any of Examples 1 to 5, wherein the logic is further to complete a transaction with a cloud-based service proximate to the display.

Example 7 may include a semiconductor package apparatus, comprising a substrate, and logic coupled to the substrate, wherein the logic is at least partly implemented in one or more of configurable logic and fixed-functionality hardware logic, the logic coupled to the substrate to determine if a user is proximate to a display, determine a characteristic of the user, display a message on the display based on the characteristic of the user, and complete a transaction with the user proximate to the display.

Example 8 may include the apparatus of Example 7, wherein the logic is further to track locations of the user relative to articles, and display a message on the display based on the tracked locations of the user relative to the articles.

Example 9 may include the apparatus of Example 7, wherein the logic is further to determine if the user interacts with an article, and display a message on the display based on the interaction with the article.

Example 10 may include the apparatus of Example 7, wherein the logic is further to display a message on the display which is personalized for the user, and display a value offer which is personalized for the user.

Example 11 may include the apparatus of Example 10, wherein the logic is further to display a limited time value offer to the user.

Example 12 may include the apparatus of any of Examples 7 to 11, wherein the logic is further to complete a transaction with a cloud-based service proximate to the display.

Example 13 may include a method of facilitating a sale, comprising determining if a user is proximate to a display, determining a characteristic of the user, displaying a message on the display based on the characteristic of the user, and completing a transaction with the user proximate to the display.

Example 14 may include the method of Example 13, further comprising tracking locations of the user relative to articles, and displaying a message on the display based on the tracked locations of the user relative to the articles.

Example 15 may include the method of Example 13, further comprising determining if the user interacts with an article, and displaying a message on the display based on the interaction with the article.

Example 16 may include the method of Example 13, further comprising displaying a message on the display which is personalized for the user, and displaying a value offer which is personalized for the user.

Example 17 may include the method of Example 16, further comprising displaying a limited time value offer to the user.

Example 18 may include the method of any of Examples 13 to 17, further comprising completing a transaction with a cloud-based service proximate to the display.

Example 19 may include at least one computer readable medium, comprising a set of instructions, which when executed by a computing device, cause the computing device to determine if a user is proximate to a display, determine a characteristic of the user, display a message on the display based on the characteristic of the user, and complete a transaction with the user proximate to the display.

Example 20 may include the at least one computer readable medium of Example 19, comprising a further set of instructions, which when executed by the computing device, cause the computing device to track locations of the user relative to articles, and display a message on the display based on the tracked locations of the user relative to the articles.

Example 21 may include the at least one computer readable medium of Example 19, comprising a further set of instructions, which when executed by the computing device, cause the computing device to determine if the user interacts with an article, and display a message on the display based on the interaction with the article.

Example 22 may include the at least one computer readable medium of Example 19, comprising a further set of instructions, which when executed by the computing device, cause the computing device to display a message on the display which is personalized for the user, and display a value offer which is personalized for the user.

Example 23 may include the at least one computer readable medium of Example 22, comprising a further set of instructions, which when executed by the computing device, cause the computing device to display a limited time value offer to the user.

Example 24 may include the at least one computer readable medium of any of Examples 19 to 23, comprising a further set of instructions, which when executed by the computing device, cause the computing device to complete a transaction with a cloud-based service proximate to the display.

Example 25 may include an instant checkout display apparatus, comprising means for determining if a user is proximate to a display, means for determining a characteristic of the user, means for displaying a message on the display based on the characteristic of the user, and means for completing a transaction with the user proximate to the display.

Example 26 may include the apparatus of Example 25, further comprising means for tracking locations of the user relative to articles, and means for displaying a message on the display based on the tracked locations of the user relative to the articles.

Example 27 may include the apparatus of Example 25, further comprising means for determining if the user interacts with an article, and means for displaying a message on the display based on the interaction with the article.

Example 28 may include the apparatus of Example 25, further comprising means for displaying a message on the display which is personalized for the user, and means for displaying a value offer which is personalized for the user.

Example 29 may include the apparatus of Example 28, further comprising means for displaying a limited time value offer to the user.

Example 30 may include the apparatus of any of Examples 25 to 29, further comprising means for completing a transaction with a cloud-based service proximate to the display.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An electronic processing system, comprising:
a processor;
memory communicatively coupled to the processor;
a display communicatively coupled to the processor; and
logic communicatively coupled to the processor to:
determine if a user is proximate to the display,
determine a characteristic of the user,
display a message on the display based on the characteristic of the user, and
complete a transaction with the user proximate to the display.

2. The system of claim 1, wherein the logic is further to:
track locations of the user relative to articles; and
display a message on the display based on the tracked locations of the user relative to the articles.

3. The system of claim 1, wherein the logic is further to:
determine if the user interacts with an article; and
display a message on the display based on the interaction with the article.

4. The system of claim 1, wherein the logic is further to:
display a message on the display which is personalized for the user; and
display a value offer which is personalized for the user.

5. The system of claim 4, wherein the logic is further to:
display a limited time value offer to the user.

6. The system of claim 1, wherein the logic is further to:
complete a transaction with a cloud-based service proximate to the display.

7. A semiconductor package apparatus, comprising:
a substrate; and
logic coupled to the substrate, wherein the logic is at least partly implemented in one or more of configurable logic and fixed-functionality hardware logic, the logic coupled to the substrate to:
determine if a user is proximate to a display,
determine a characteristic of the user,
display a message on the display based on the characteristic of the user, and
complete a transaction with the user proximate to the display.

8. The apparatus of claim 7, wherein the logic is further to:
track locations of the user relative to articles; and
display a message on the display based on the tracked locations of the user relative to the articles.

9. The apparatus of claim 7, wherein the logic is further to:
determine if the user interacts with an article; and
display a message on the display based on the interaction with the article.

10. The apparatus of claim 7, wherein the logic is further to:
display a message on the display which is personalized for the user; and
display a value offer which is personalized for the user.

11. The apparatus of claim 10, wherein the logic is further to:
display a limited time value offer to the user.

12. The apparatus of claim 7, wherein the logic is further to:
complete a transaction with a cloud-based service proximate to the display.

13. A method of facilitating a transaction, comprising:
determining if a user is proximate to a display;
determining a characteristic of the user;
displaying a message on the display based on the characteristic of the user; and
completing a transaction with the user proximate to the display.

14. The method of claim 13, further comprising:
tracking locations of the user relative to articles; and
displaying a message on the display based on the tracked locations of the user relative to the articles.

15. The method of claim 13, further comprising:
determining if the user interacts with an article; and
displaying a message on the display based on the interaction with the article.

16. The method of claim 13, further comprising:
displaying a message on the display which is personalized for the user; and
displaying a value offer which is personalized for the user.

17. The method of claim 16, further comprising:
displaying a limited time value offer to the user.

18. The method of claim 13, further comprising:
completing a transaction with a cloud-based service proximate to the display.

19. At least one computer readable medium, comprising a set of instructions, which when executed by a computing device, cause the computing device to:
determine if a user is proximate to a display;
determine a characteristic of the user;
display a message on the display based on the characteristic of the user; and
complete a transaction with the user proximate to the display.

20. The at least one computer readable medium of claim 19, comprising a further set of instructions, which when executed by the computing device, cause the computing device to:
track locations of the user relative to articles; and
display a message on the display based on the tracked locations of the user relative to the articles.

21. The at least one computer readable medium of claim 19, comprising a further set of instructions, which when executed by the computing device, cause the computing device to:
determine if the user interacts with an article; and
display a message on the display based on the interaction with the article.

22. The at least one computer readable medium of claim 19, comprising a further set of instructions, which when executed by the computing device, cause the computing device to:
display a message on the display which is personalized for the user; and
display a value offer which is personalized for the user.

23. The at least one computer readable medium of claim 22, comprising a further set of instructions, which when executed by the computing device, cause the computing device to:
display a limited time value offer to the user.

24. The at least one computer readable medium of claim 19, comprising a further set of instructions, which when executed by the computing device, cause the computing device to:
complete a transaction with a cloud-based service proximate to the display.
